(19) United States
(12) Patent Application Publication
(10) Pub. No.: US 2006/0172888 A1
(43) Pub. Date: Aug. 3, 2006

(54) Natural grass fertilizer with weed and grub control activity

(76) Inventors: Roman Blaszczyk, London (CA); John Peake, London (CA)

Correspondence Address: NORRIS MCLAUGHLIN & MARCUS, P.A., P O BOX 1018, SOMERVILLE, NJ, 08876, US

(21) Appl. No.: 11/049,816

(22) Filed: Feb. 3, 2005

(51) Int. Cl. C05D 9/02; A01N 59/04

(52) U.S. Cl. 504/101; 71/11

(57) ABSTRACT

A fertilizer, such as a natural grass fertilizer, having weed and grub control activity comprising steepwater and at least one of spent filter aid and biomass. Also, a process for making the fertilizer and methods for promoting plant growth, inhibiting weed growth and grub control.

### BACKGROUND OF THE INVENTION

1. The Field of the Invention

The invention relates to a fertilizer, such as a natural grass fertilizer, having weed and grub control activity. The fertilizer composition comprises steepwater and at least one of spent filter aid and biomass. The invention further pertains to a process for making the fertilizer, and methods of application.

2. The Related Art

In corn wet milling technology, corn kernels are steeped in water containing sulfuric acid and some residual organics after a starch wash. After about 20 to about 40 hours of steeping, the water containing soluble matter from the corn kernel is separated from residual corn material, generally by draining the steepwater from the steeping kettles. The drained steepwater is concentrated by evaporation to about 50% dry solids content. Dry basis of the steepwater contains soluble protein, sugars, lactic acid, bioactive compounds including vitamins and amino acids, and minerals utilized by corn.

The residual corn kernels from the steeping process are ground and the germ and fiber are separated from gluten and starch by screening. The final separation of gluten from starch is done by centrifugal forces in centrifuges and cyclones. The corn starch obtained from the process can be further processed and thereby converted into corn syrups. Corn starch is converted into corn syrup by enzyme or acid hydrolyses at high temperature. The conversion liquefies the corn starch and the resulting liquid contains residual proteins and fats, which are removed from the bulk of syrup on the surface of diatomaceous earth (filter aid), generally in drum vacuum filters which produces spent filter aid. The spent filter aid will comprise diatomaceous earth, protein and elements such as nitrogen, phosphorus, and potassium.

All parts and percentages in this specification and the claims are on a weight by weight basis unless stated otherwise.

### SUMMARY OF THE INVENTION

The invention pertains to a natural fertilizer having weed and grub control activity comprising steepwater and at least one of spent filter aid and biomass. In the natural fertilizer, the steepwater has weed suppression activity, the spent filter aid provides grub control activity (due to content of diatomaceous earth), and the biomass provides additional nitrogen, potassium, phosphorus, and other micronutrients. In addition, slowly decomposed solids contained in the fertilizer (e.g. diatomaceous earth and traces of carbon powder) will improve soil quality over a long period of time after application and will also improve water retention and transportation in the soil around the root system of the grass.

The fertilizer may be made by combining liquid steepwater with other ingredients or by a dry granulation technique. The fertilizer can be used in methods to promote grass and/or plant growth, inhibit weed growth and grub control.

### DETAILED DESCRIPTION OF THE INVENTION

The fertilizer comprises steepwater and at least one of spent filter aid and/or biomass. For example, the fertilizer may comprise up to about 80% steepwater, and at least one of up to about 80% spent filter aid and up to about 80% biomass. The fertilizer may comprise steepwater, spent filter aid and biomass. Preferably the ratio of steepwater:spent filter aid:biomass is from about 1:1:5 to about 5:5:1, including the ratio of about 1:5:5 to about 5:1:1. In an embodiment of the invention, the ratio of steepwater:spent filter aid:biomass is about 1:1:1. The fertilizer may comprise, consist essentially of or consist of one or more of steepwater, spent filter aid and/or biomass, such as consisting essentially of or consisting of steepwater and spent filter aid, with or without biomass. The fertilizer is preferably an essentially dry material, however, a wet fertilizer comprising water as a solvent is within the scope of the invention.

When corn or other grains are subjected to the wet-milling process, the grain is first soaked in warm water which usually contains a small amount of sulfur dioxide. When wheat is subjected to the wet-milling process, sulfur dioxide is not ordinarily added to the water, since it destroys the vitality of wheat gluten. After the grain is removed, the residual aqueous solution containing various substances which have leached out of the grain is often referred to as steepwater and as used herein the term steepwater shall mean water containing soluble matter from grain obtained from steeping grain and, because the fertilizer of the invention may be in dry form, the term steepwater shall be understood to also include the residue from the partial to complete drying of this water containing soluble matter (i.e., dried steepwater). In an embodiment of the invention, the steepwater is generally obtained from the steeping of corn kernels from a corn milling process.

The steepwater may have from about 40% to about 60% dry solids, such as having about 50% dry solids. Thus, when the fertilizer is in dry form, the steepwater is the completely or partially dried residue of steepwater preferably having a dry solids content, prior to drying, of about 40% to about 60%, most preferably about 50%. The steepwater is dried by having a substantial portion or all of the moisture drained and/or evaporated from the water containing soluble matter for use in the invention.

The spent filter aid may be obtained from the separation of liquid corn starch from residual proteins and fats during the production of corn syrup using diatomaceous earth filters (i.e., filter aid). As used herein, the term spent filter aid shall mean filter aid, including diatomaceous earth, which has been used for removal of material, including removal of residual proteins and fats from bulk syrup, such as from bulk corn syrup or other grain syrup and also includes the residue from drying the filter aid. The role of the spent filter aid in the new fertilizer is to disable grubs by diatomaceous earth leached from the spent filter aid. Preferably, the spent filter aid comprises from about 1% to about 80% diatomaceous earth, depending on the filtration rate. The amount of diatomacebus earth in the spent filter aid may be about 20% to about 35%, such as about 25%.

The spent filter aid also provides the fertilizer with phosphorous, nitrogen and potassium. The spent filter aid used in the fertilizer should comprise at least 20%, preferably at least 30%, protein to provide adequate phosphorous, nitrogen and potassium to the fertilizer. For example, the spent filter aid may comprise from about 20% to about 35% protein material.

The biomass is generally created from waste activated sludge (“WAS”). As used herein, WAS means the resulting product from the digestion of residual proteins, sugars, and fats by activated sludge in a sufficient presence of oxygen. The residual proteins, sugars, and fats digested by the activated sludge may be a by-product of corn syrup refining or other grain refining. The WAS is thickened by gravity, dewatered with food grade polymer and concentrated in a centrifuge or a vacuum filter to obtain the biomass used in the fertilizer and, as used herein, the term biomass means the end product of the processing of WAS and includes the residue from drying the end product of the processing of WAS. The biomass should comprise at least about 10% dry matter, preferably at least about 20% of dry matter. For example, the biomass may have from about 6% to about 30% dry matter. Also, completely dry biomass, that is biomass having a dry matter content of at least about 90% may be used. The biomass provides additional nitrogen, potassium, phosphorus, organic carbon and other micronutrients to the fertilizer.

The fertilizer may be made by a process comprising the steps of blending the ingredients, drying the ingredients and then granulating the dry blend. In an embodiment of the invention, the blending and drying steps are done concurrently to avoid the steepwater from lumping during drying due to the relatively high viscosity of the steepwater. Also, it is preferable to add a small amount of heavy steepwater, in addition to the steepwater ingredient, to the recycling solids during the granulation step to avoid lumping and promote granulation. The fertilizer may also be made by first drying the ingredients using conventional techniques and then dry blending the dried ingredients. Drying some of the ingredients and then mixing with ingredients is also within the scope of the invention.

The fertilizer is preferably a natural grass fertilizer. As such, the fertilizer is useful for applying to turf grass such as that generally found at ball fields, golf courses, parks and other areas, as well as home lawns. Accordingly, the invention pertains to methods for promoting plant growth, inhibiting weed growth and/or grub control for turf grass comprising the step of applying the fertilizer described herein to a substrate selected from the group consisting of the root structure of the plant material, soil proximate to the root structure of the plant material and/or growth medium proximate to the root structure of the plant material, such as potting mix, artificial growth substrates, and hydrophonic growth media.

### EXAMPLE

A fertilizer composition comprising steepwater, spent filter aid and biomass at a weight ratio of 1:1:1 was prepared. The fertilizer was made by initially drying biomass to 94% dry solids. The 94% dry solids biomass was then mixed with wet filter aid in a conventional pilot scale mixer. Next, steepwater was slowly added to the biomass and filter aid in the mixer, under continuous mixing for up to 12 hours at about 50° C. to obtain the fertilizer composition. A shear mixing condition was maintained within the mixer during the continuous mixing.

The fertilizer composition made as described above was tested on at least the 9 weed species and 2 fine turf grass species as listed below.

Weed Species

Black medic (Medicago lupulina)

Dandelion (Taraxacum officinale)

Foxtail (Green) (Setaria viridis)

Common Groundsel (Senecio vulgaris)

Buckhorn Plantain (Plantago lanceolata)

Sweetclover, White (Melilotus alba)

Foxtail (Yellow) (Setaria lutescens)

Annual Bluegrass (Poa annua)

Large Crabgrass (Digitaria sanguinalis)

Fine Turf Species

Kentucky bluegrass (Poa pratensis)

Perennial ryegrass (Lolium perenne)

Two samples of each of the weed and fine turf grass species were prepared in 2 centimeter diameter by 11 centimeter deep plastic forestry tubes filled to the rim with Pro-Mix potting soil mix. The seeding rate was 30 seeds per tube. The fertilizer composition was applied to each species at a rate of 100 g/m², and the non-treated tubes were maintained as control samples. The fertilizer was sprinkled on the soil surface along with the seeds. The tubes were maintained moist until germination began and were then irrigated to prevent stress. The tubes were periodically observed and germination and establishment of plant growth were assessed by counting seedlings. The plants were harvested seven weeks after seeding. The data regarding the number of seedlings per tube for each species at 4, 10, 18 and 27 days after seeding (“DAS”) and at harvest is set forth in Table 1. In Table 1, “Treated” refers to the sample having applied fertilizer.

TABLE 1
Germination/establishment of weed and turfgrass
species Number of seedlings per tube

| | | | | | | |
|---|---|---|---|---|---|---|
| | | | | | | % |
| | | | | | | reduction |
| 4 | 10 | 18 | 27 | 49 DAS | Maximum | relative to |
| DAS | DAS | DAS | DAS | harvest | count | control |

Buckhorn plantation

| | | | | | | | |
|---|---|---|---|---|---|---|---|
| Control | 0 | 11.3 | 12.5 | 11.3 | 10.3 | 12.5 | |
| Treated | 0 | 7.5 | 10.5 | 9.0 | 7.8 | 10.5 | 16.0 |

Common groundsel

| | | | | | | | |
|---|---|---|---|---|---|---|---|
| Control | 8.5 | 10.8 | 9.8 | 8.3 | 7.5 | 10.8 | |
| Treated | 8.0 | 7.3 | 4.3 | 3.8 | 3.5 | 7.3 | 32.6 |

Dandelion

| | | | | | | | |
|---|---|---|---|---|---|---|---|
| Control | 9.5 | 16.5 | 14.8 | 11.3 | 12.3 | 16.5 | |
| Treated | 2.3 | 12.8 | 13.0 | 8.3 | 7.3 | 13.0 | 21.2 |

Black medic

| | | | | | | | |
|---|---|---|---|---|---|---|---|
| Control | 9.3 | 13.5 | 11.8 | 10.3 | 9.3 | 13.5 | |
| Treated | 8.0 | 11.3 | 7.0 | 4.8 | 4.0 | 11.3 | 16.7 |

White sweetclover

| | | | | | | | |
|---|---|---|---|---|---|---|---|
| Control | 16.8 | 18.8 | 16.0 | 14.8 | 12.8 | 18.8 | |
| Treated | 18.5 | 23.3 | 19.3 | 16.3 | 14.5 | 23.3 | increase |

Annual Bluegrass

| | | | | | | | |
|---|---|---|---|---|---|---|---|
| Control | 1.3 | 19.8 | 18.8 | 19.5 | 16.8 | 19.8 | |
| Treated | 0.0 | 18.5 | 14.0 | 11.8 | 12.0 | 18.5 | 6.3 |

Green foxtail

| | | | | | | | |
|---|---|---|---|---|---|---|---|
| Control | 10.5 | 20.5 | 18.8 | 17.5 | 18.0 | 20.5 | |
| Treated | 5.5 | 19.5 | 19.0 | 18.0 | 16.3 | 19.5 | 4.9 |

Yellow foxtail

| | | | | | | | |
|---|---|---|---|---|---|---|---|
| Control | 0.0 | 6.8 | 9.3 | 10.3 | 9.8 | 10.3 | |
| Treated | 0.0 | 7.0 | 10.3 | 9.3 | 8.0 | 10.3 | 0.0 |

Large crabgrass

| | | | | | | | |
|---|---|---|---|---|---|---|---|
| Control | 0.0 | 0.8 | 4.0 | 2.8 | 3.0 | 4.0 | |
| Treated | 0.0 | 0.8 | 0.8 | 0.5 | 0.5 | 0.8 | 81.3 |

Perennial ryegrass

| | | | | | | | |
|---|---|---|---|---|---|---|---|
| Control | 18.5 | 25.5 | 23.0 | 18.8 | 21.5 | 25.5 | |
| Treated | 19.0 | 27.8 | 26.0 | 23.3 | 24.0 | 27.8 | increase |

Kentucky bluegrass

| | | | | | | | |
|---|---|---|---|---|---|---|---|
| Control | 0.0 | 14.0 | 14.5 | 11.8 | 11.5 | 14.5 | |
| Treated | 0.0 | 11.5 | 12.3 | 12.8 | 10.3 | 12.8 | 12.1 |

We claim:

1. A fertilizer composition comprising steepwater and at least one of spent filter aid and biomass.

2. The fertilizer of claim 1 comprising up to about 80% steepwater and at least one of up to about 80% spent filter aid and up to about 80% biomass.

3. The fertilizer of claim 1 comprising steepwater, spent filter aid and biomass.

4. The fertilizer of claim 3 wherein the weight ratio of steepwater:spent filter aid:biomass is about 1:1:5 to about 5:5:1.

5. The fertilizer of claim 4 wherein the ratio of steepwater:spent filter aid:biomass is about 1:5:5 to about 5:1:1.

6. The fertilizer of claim 1 wherein the steepwater is dried steepwater.

7. The fertilizer of claim 6 wherein the dried steepwater is the residue of steepwater having a dry solids content, prior to drying, of about 40% to about 60%.

8. The fertilizer of claim 1 wherein the spent filter aid comprises from about 25% to about 35% diatomaceous earth.

9. The fertilizer of claim 1 wherein the spent filter aid comprises from about 20% to about 35% protein.

10. The fertilizer of claim 1 wherein the biomass comprises from about 6% to about 30% dry matter.

11. The fertilizer of claim 1 wherein the biomass has a dry content matter of at least about 90%.

12. The fertilizer of claim 1 wherein the steepwater comprises soluble matter from the steeping of corn.

13. The fertilizer of claim 1 wherein the spent filter aid comprises residual proteins and fats from bulk corn syrup.

14. A method for promoting plant growth comprising the step applying the fertilizer of claim 1 to a substrate selected from the group consisting of a root structure of plant material, soil proximate to the root structure of the plant material, a growth medium proximate to the root structure of the plant material and combinations thereof.

15. The method of claim 14 wherein the plant material is turf grass.

16. A method of inhibiting weed growth comprising the step applying the fertilizer of claim 1 to a substrate selected from the group consisting of a root structure of plant material, soil proximate to the root structure of the plant material, a growth medium proximate to the root structure of the plant material and combinations thereof.

17. The method of claim 16 wherein the plant material is turf grass.

18. A method of grub control comprising the step of applying the fertilizer of claim 1 to a substrate selected from the group consisting of a root structure of plant material, soil proximate to the root structure of the plant material, a growth medium proximate to the root structure of the plant material and combinations thereof.

19. A process for making fertilizer comprising the steps of concurrently blending and drying steepwater and at least one of spent filter aid and biomass to obtain a dry blend and then granulating the dry blend.

20. The process of claim 1 comprising the additional step of adding steepwater during the granulation step.
